(19) United States
(12) Patent Application Publication
(10) Pub. No.: US 2025/0243340 A1
(43) Pub. Date: Jul. 31, 2025

(54) SYNTHESIS OF MELAMINE POLYMER MODIFIED ZINC OXIDE NANOPARTICLES AS A CORROSION INHIBITOR

(71) Applicants: SAUDI ARABIAN OIL COMPANY, Dhahran (SA); King Fahd University of Petroleum and Minerals, Dhahran (SA)

(72) Inventors: Norah Aljeaban, Al Khobar (SA); Bader Ghazi Al-Harbi, Dammam (SA); Tawfik A. Saleh, Dhahran (SA)

(73) Assignees: SAUDI ARABIAN OIL COMPANY, Dhahran (SA); King Fahd University of Petroleum and Minerals, Dhahran (SA)

(21) Appl. No.: 18/428,809

(22) Filed: Jan. 31, 2024

(51) Int. Cl. C08K 3/22; C08L 61/28; C09K 8/54

(52) U.S. Cl. CPC C08K 3/22; C08L 61/28; C09K 8/54; C08K 2003/2296; C08K 2201/011; C09K 2208/10; C09K 2208/32

(57) ABSTRACT

A method for synthesizing melamine polymer modified zinc oxide nanoparticles is provided. In the method, polymer grafted zinc oxide nanoparticles are provided, and melamine is grafted onto the polymer grafted zinc oxide nanoparticles by adding melamine in the presence of a carboxy group activating reagent to the polymer grafted zinc oxide nanoparticles to form the melamine polymer modified zinc oxide nanoparticles. A method of corrosion inhibition in a wellbore by applying the melamine polymer modified zinc oxide nanoparticles is also provided. Further provided are zinc oxide nanoparticles comprising a melamine polymer of the following formula bonded to oxygen atoms are provided:

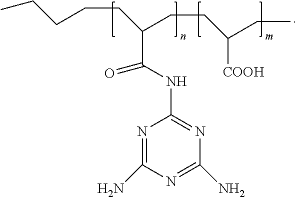

### TECHNICAL FIELD

The present disclosure relates to modified nanoparticles, and in particular melamine modified nanoparticles.

### BACKGROUND

It can be difficult to prevent petroleum from flowing quickly into a wellbore when it is present in formations with very low permeability. The typical solution for this poor permeability issue is to stimulate the well, which enlarges existing channels and creates new ones. The most frequently used method for stimulating oil and gas wells to increase output is acidizing. Acidizing entails injecting a hot acid solution into the wellbore to acidify the water, which increases the productivity of oil wells by eliminating mud and developing channels in rocks to allow oil to flow into the wells. Acidizing methods can also be used to restore the maximum productivity of aged wells by dissolving dirt and debris. Common acids used in the acidizing treatments include formic acid, acetic acid, hydrochloric acid, hydrofluoric acid, nitric acid, sulfonic acid, and chloroacetic acid are common acids, with hydrochloric acid being the most prevalent.

The acidizing process, however, can expose the carbon steel construction of a well to a severe, highly corrosive acid medium. Corrosion of carbon steel can have significant economic effects and environmental impacts due to the extensive use of carbon steel in numerous building industries.

To lessen to the impact of acids on the carbon steel, corrosion inhibitors are often applied as chemical additives. Some of the most common and commercially available corrosion inhibitors for acidizing processes include formulations of aromatic aldehydes, quaternary salts, acetylenic alcohols, N-containing heterocyclics, carbonyls, and amines. However, these conventional inhibitors are costly, poisonous, unfriendly to the environment, and are only effective at very high concentrations. Therefore, there is a need for new inhibitors that are inexpensive, nontoxic, and beneficial to the environment.

The present application addresses these and other challenges related to corrosion inhibitors, as well as inhibiting corrosion caused by acidizing treatments.

In a first aspect, a method for synthesizing melamine polymer modified zinc oxide nanoparticles is provided. In the method, polymer grafted zinc oxide nanoparticles are first provided. Melamine is then grafted onto the polymer grafted zinc oxide nanoparticles by adding melamine in the presence of a carboxy group activating reagent to the polymer grafted zinc oxide nanoparticles to form the melamine polymer modified zinc oxide nanoparticles.

In another aspect, the carboxy group activating reagent comprises N,N′-Dicyclohexylcarbodiimide (DCC).

In another aspect, the step of grafting melamine comprises dispersing the polymer grafted zinc oxide nanoparticles in a polar solvent. In a further aspect, the polar solvent comprises dimethyl sulfoxide.

In another aspect, the step of grafting melamine onto the polymer grafted zinc oxide nanoparticles further comprises stirring the polymer grafted zinc oxide nanoparticles, melamine, the polar solvent and the carboxy group activating reagent for about 2-8 hours at a temperature of about 60-100° C.

In another aspect, the step of grafting melamine onto the polymer grafted zinc oxide nanoparticles further comprises stirring the polymer grafted zinc oxide nanoparticles, dimethyl sulfoxide, melamine, and N,N′-Dicyclohexylcarbodiimide as the carboxy group activating reagent for approximately 10 hours at approximately 90° C.

In another aspect, the method further comprises a step of drying the melamine polymer modified zinc oxide nanoparticles.

In another aspect, the polymer grafted zinc oxide nanoparticles are formed by: mixing zinc acetate dihydrate with diethylene glycol and triethylene to form zinc oxide nanoparticles; dispersing the zinc oxide nanoparticles in NaOH under sonication; combining allyl chloride with the dispersed zinc oxide nanoparticles to form allyl modified zinc oxide nanoparticles, wherein the allyl chloride is added in an equal ratio to the zinc oxide; dispersing the allyl modified zinc oxide nanoparticles in dimethyl sulfide; and adding acrylic acid to the dispersed allyl modified zinc oxide nanoparticles and initiating a polymerization reaction of the dispersed allyl modified zinc oxide nanoparticles with potassium persulfate solution to produce the polymer grafted zinc oxide nanoparticles. In a further aspect, the diethylene glycol and triethylene are in equal ratio when mixed with zinc acetate dihydrate.

In another aspect, the step of mixing zinc acetate dihydrate with diethylene glycol and triethylene includes refluxing the mixture of zinc acetate dihydrate, diethylene glycol, and triethylene. In a further aspect, the step of mixing comprises: refluxing the mixture of zinc acetate dihydrate, diethylene glycol, and triethylene for approximately 4 hours at 180° C.; adding sodium acetate to the mixture; further refluxing the mixture for approximately 2 hours at 180° C.; and cooling the mixture.

In another aspect, the acrylic acid is added to the dispersed allyl modified zinc oxide nanoparticles under the flow of nitrogen.

In another aspect, the step of adding acrylic acid and initiating a polymerization reaction further comprises refluxing the mixture of acrylic acid, dispersed allyl modified zinc oxide nanoparticles and potassium persulfate solution for approximately 4 hours.

In a second aspect, provided are zinc oxide nanoparticles comprising a melamine polymer of the following formula bonded to oxygen atoms:

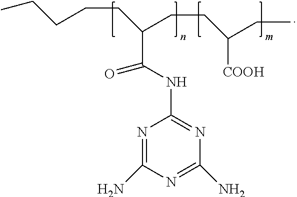

In a third aspect, a method of corrosion inhibition in a wellbore is provided. In the method, a corrosion inhibitor composition comprising the melamine polymer modified zinc oxide nanoparticles as described herein is applied to the wellbore.

In another aspect, the wellbore comprises carbon steel.

In another aspect, the corrosion inhibitor composition inhibits corrosion caused by one or more of hydrochloric acid, formic acid, acetic acid, hydrofluoric acid, nitric acid, sulfonic acid, and chloroacetic acid.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

The processes of the present disclosure will be described in more detail below and with reference to the attached drawing.

FIG. 1A displays a flow diagram of the steps of a method for synthesizing melamine polymer modified zinc oxide nanoparticles in accordance with one or more embodiments.

FIG. 1B displays a flow diagram of the steps of a method for preparing polymer modified zinc oxide nanoparticles in accordance with one or more embodiments.

FIG. 2A displays a diagram of an exemplary reaction to form zinc oxide nanoparticles in accordance with one or more embodiments.

FIG. 2B displays a diagram of an exemplary reaction to form allyl modified zinc oxide nanoparticles in accordance with one or more embodiments.

FIG. 2C displays a diagram of an exemplary reaction to form polymer modified zinc oxide nanoparticles in accordance with one or more embodiments.

FIG. 2D displays a diagram of an exemplary reaction to form melamine grafted-polymer modified zinc oxide nanoparticles in accordance with one or more embodiments.

### DETAILED DESCRIPTION OF CERTAIN EMBODIMENTS

Disclosed herein are melamine polymer modified zinc oxide nanoparticles and methods for inhibiting corrosion in a wellbore with the melamine polymer modified zinc oxide nanoparticles. Also disclosed herein are methods for synthesizing the melamine polymer modified zinc oxide nanoparticles. The resulting melamine polymer modified zinc oxide nanoparticles can be utilized as corrosion inhibitors to prevent or lessen the effects of corrosion caused by acidizing treatments on carbon steel. In comparison with conventional corrosion inhibition strategies, such as existing corrosion inhibitors, polymeric coatings, and the use of inert metals, the melamine polymer modified zinc oxide nanoparticles of the present application provide a larger surface area, are less expensive to produce, and are more environmentally benign. Moreover the melamine modified nanoparticles of the present application can exhibit improved mechanical strength and chemical resistance, and high levels impermeability relative to conventional inhibitors. The melamine polymer modified zinc oxide nanoparticles of the present application are synthesized using a chemical treatment approach. The melamine polymer modified zinc oxide nanoparticles can act as corrosion inhibitors and can include branches of amine containing groups on the nanoparticles. In one or more embodiments, the melamine polymer modified zinc oxide nanoparticles of the present application can inhibit corrosion caused by one or more of hydrochloric acid, formic acid, acetic acid, hydrofluoric acid, nitric acid, sulfonic acid, and chloroacetic acid.

These and other aspects of the present modified nanoparticles and corresponding methods are described in further detail below. Further, as used in the present application, the term “approximately” or “about” when used in conjunction with a numerical value refers to any number within about 5, 3 or 1% of the referenced numerical value, including the referenced numerical value.

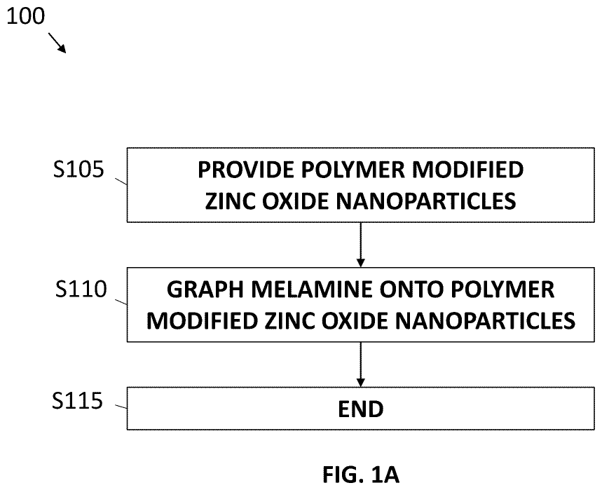

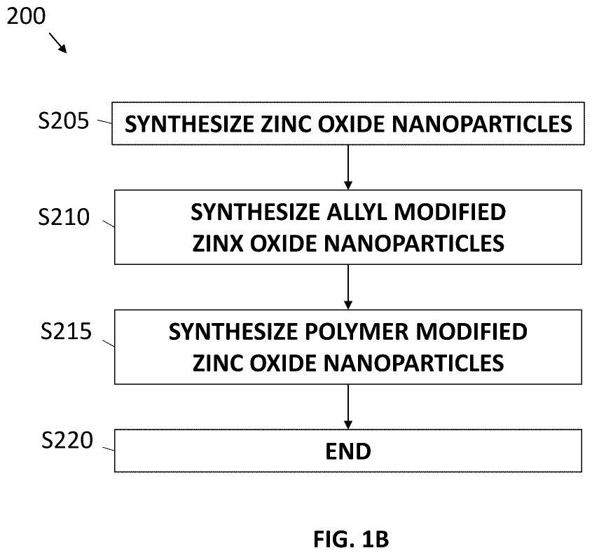

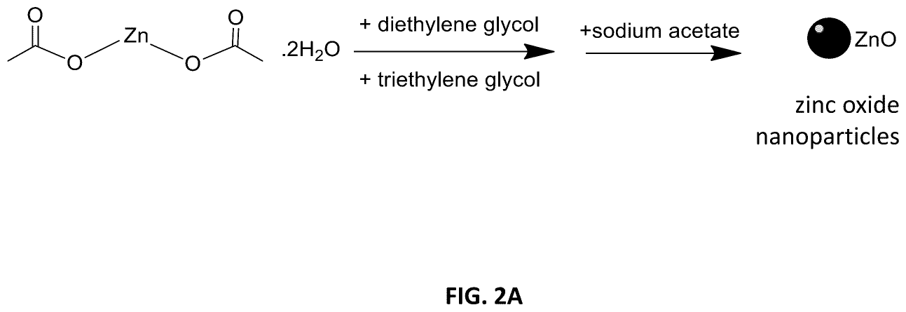

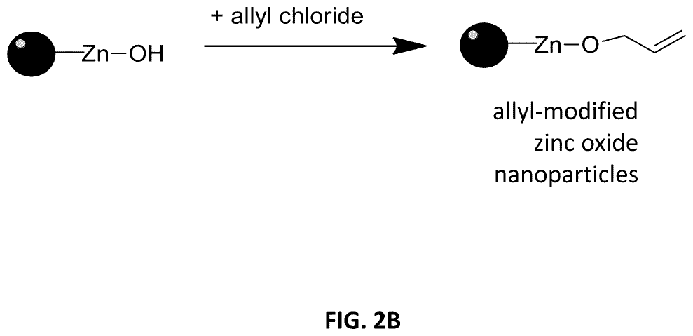

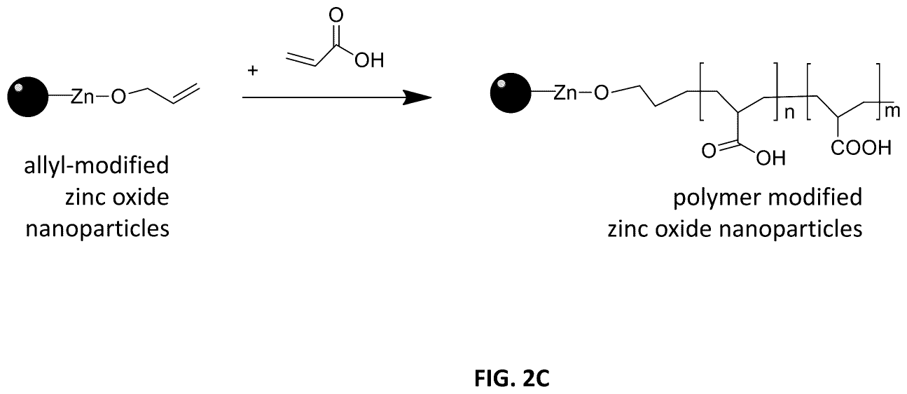

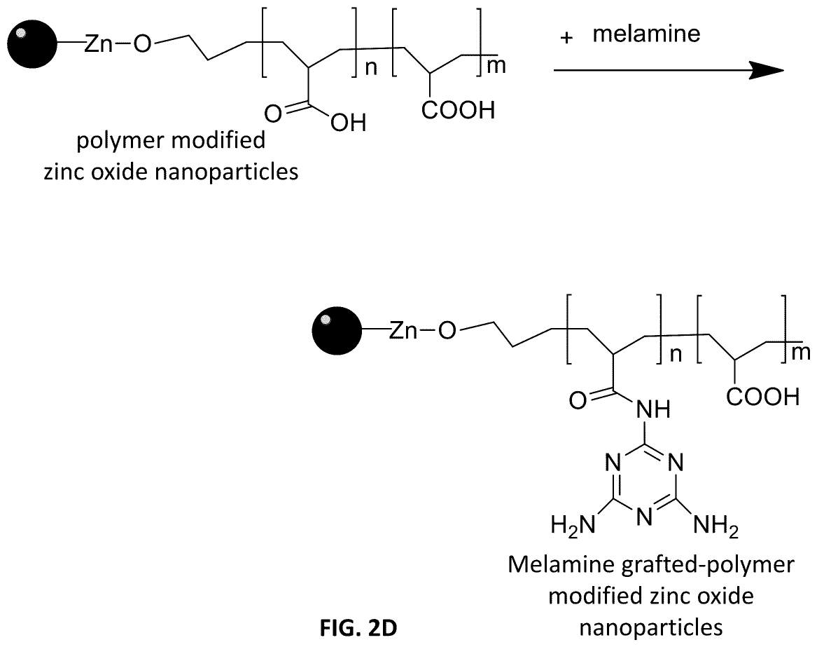

FIG. 1A displays a flow diagram of the steps of a method 100 for synthesizing melamine polymer modified zinc oxide nanoparticles in accordance with one or more embodiments. With reference to FIG. 1A, the method 100 begins at step S105, where polymer modified (polymer grafted) zinc oxide nanoparticles are provided. A chemical diagram of the polymer modified (polymer grafted) zinc oxide nanoparticle is shown in FIG. 2D in accordance with one or more embodiments. The polymer modified (polymer grafted) zinc oxide nanoparticles can be synthesized in a number of ways, as described in further detail below with reference to FIG. 1B.

With continued reference to FIG. 1A, at step S110, melamine is graphed onto the polymer modified zinc oxide nanoparticles to produce melamine polymer modified zinc oxide nanoparticles. The melamine is grafted onto the polymer modified zinc oxide nanoparticles by adding melamine in the presence of a carboxy group activating reagent to the polymer modified zinc oxide nanoparticles to form the melamine polymer modified zinc oxide nanoparticles. In certain embodiments, the polymer modified zinc oxide nanoparticles are first dispersed in a polar solvent prior to the addition of melamine and the carboxy group activating reagent. In one or more embodiments, the carboxy group activating reagent is N,N′-Dicyclohexylcarbodiimide (DCC). In one or more embodiments, the carboxy group activating reagent can be N,N′-Diisopropylcarbodiimide (DIC) or ethyl-(N′,N′-dimethylamino)propylcarbodiimide hydrochloride (EDC). In one or more embodiments, the polar solvent is dimethyl sulfoxide, ethyl acetate, pyridine, sulfolane, or tetrahydrofuran, for example.

In one or more embodiments, the resulting mixture of the polymer modified zinc oxide nanoparticles, polar solvent, melamine, and the carboxy group activating reagent is stirred for a period to produce the melamine grafted-polymer modified zinc oxide nanoparticles. In one or more embodiments, the mixture is stirred for approximately 2-8 hours at a temperature of approximately 60-100° C. In at least one embodiment, the mixture is stirred for approximately 10 hours at approximately 90° C. After the stirring step, the final product, melamine grafted-polymer modified zinc oxide nanoparticles, are separated from the mixture (e.g., via centrifuge) and dried.

FIG. 2D displays a diagram of an exemplary reaction to form the melamine polymer modified zinc oxide nanoparticles from the polymer modified zinc oxide nanoparticles produced in accordance with one or more embodiments. The polymer modified zinc oxide nanoparticles are first dispersed in dimethyl sulfoxide (polar solvent) and the resulting dispersion is then mixed with melamine and N,N′-Dicyclohexylcarbodiimide (DCC) (carboxy group activating reagent) The resulting mixture is then stirred for a period to produce the melamine grafted-polymer modified zinc oxide nanoparticles.

Referring again the FIG. 1A, at step S115, the method 100 ends.

FIG. 1B displays a flow diagram of the steps of a method 200 for preparing polymer modified zinc oxide nanoparticles in accordance with one or more embodiments. As discussed above, in certain embodiments, the polymer modified (polymer grafted) zinc oxide nanoparticles can be synthesized in a number of ways. However, FIGS. 1B and 2A-2C describe exemplary embodiments for preparing the polymer modified zinc oxide nanoparticles in accordance with one or more embodiments herein.

With specific reference now to FIG. 1B, the method 200 begins at steps S205 where zinc oxide nanoparticles are synthesized. FIG. 2A displays a diagram of exemplary reactions for synthesizing the zinc oxide nanoparticles in accordance with one or more embodiments. As exemplified in FIG. 2A, zinc acetate dihydrate (Zn(CH₃COO)₂(H₂O)₂) is mixed with diethylene glycol and triethylene glycol. In one or more embodiments, the diethylene glycol and triethylene glycol are in equal ratio to one another. The mixture of zinc acetate dihydrate, diethylene glycol, and triethylene glycol are then kept under reflux. In one or more embodiments, the mixture is kept under reflux for approximately 4 hours and at 180° C. In one or more embodiments, the mixture is kept under reflux for approximately 2-8 hours and at a temperature in the range of approximately 120-220° C. Sodium acetate is then added to the mixture, and this further mixture is then refluxed for an additional period. In one or more embodiments, the additional period is approximately 2-4 hours and the additional reflux occurs at approximately the same temperature as the initial reflux (e.g., 180° C.). These steps result in the production of zinc oxide nanoparticles in the mixture. After reflux, the mixture is cooled and the zinc oxide nanoparticles are separated via centrifuge. In at least one embodiment, the zinc oxide nanoparticles are separated via filtration.

With continued reference to FIG. 1B, the method 200 continues at step S210, where allyl-modified zinc oxide nanoparticles are synthesized. FIG. 2B displays a diagram of exemplary reactions for producing the allyl-modified zinc oxide nanoparticles in accordance with one or more embodiments. Specifically, the zinc oxide nanoparticles obtained from step S205 are dispersed in a sodium hydroxide (NaOH) solution under sonication. In certain embodiments, ammonia or potassium hydroxide (KOH) can be used in place of NaOH. In one or more embodiments, the NaOH solution is a 0.4M NaOH solution. The mixture can be sonicated for approximately 1 hour, for example. In one or more embodiments, the mixture can be sonicated for approximately 10 minutes-4 hours. After sonication, allyl chloride can be added to the mixture of zinc oxide nanoparticles and NaOH solution, as exemplified in FIG. 2B. In one or more embodiments, ally chloride is added to the mixture in approximately equal ratio to the zinc oxide present in the mixture. The mixture of allyl chloride, zinc oxide nanoparticles and NaOH solution is then kept under reflux for a period. In one or more embodiments, the reflux period is approximately 6 hours, and in one or more embodiments, the reflux can occur at approximately 80° C. In one or more embodiments, the reflux period is approximately 2-6 hours and the reflux can occur in a temperature range of approximately 60-120° C. After reflux, the resulting product (e.g., allyl-modified zinc oxide nanoparticles) is cooled and then separated from the mixture via centrifuge or filtration.

Referring again to FIG. 1B, at step S215 polymer modified zinc oxide nanoparticles are synthesized. FIG. 2C displays a diagram of exemplary reactions for producing polymer modified zinc oxide nanoparticles from the allyl-modified zinc oxide nanoparticles in accordance with one or more embodiments. The allyl-modified zinc oxide nanoparticles produced from step S210 are first dispersed in dimethyl sulfoxide, and the resulting dispersion is then mixed with acrylic acid (C₃H₄O₂) (see FIG. 2C) under the flow of nitrogen. In certain embodiments, argon, helium, or another inert gas can be used in place of nitrogen. A polymerization in the mixture is then initiated by adding a potassium persulfate solution (e.g., 0.1-2M potassium persulfate solution). The mixture is then kept under reflux for a period, such as approximately 4 hours. In one or more embodiments, the reflux period is approximately 2-6 hours and the reflux can occur in a temperature range of approximately 60-120° C. After reflux, the mixture is cooled and the produced polymer modified zinc oxide nanoparticles are separated from the mixture via centrifuge or filtration.

Referring again to FIG. 1B, at step S220 the method 200 ends.

In one or more embodiments, the method 200 can be performed prior to the method 100. In other words, in one or more embodiments, the polymer modified zinc oxide nanoparticles produced in method 200 can then be provided at step S105 in method 100 to begin the method for synthesizing melamine polymer modified zinc oxide nanoparticles.

The above aspects and other aspects of the present melamine polymer modified zinc oxide nanoparticles and the corresponding methods can be further understood through the following examples.

### Example 1

In this example, a method for synthesizing melamine polymer modified zinc oxide nanoparticles is provided in accordance with one or more embodiments. To begin the synthesis method, zinc oxide nanoparticles were first synthesized using zinc acetate dihydrate (0.1 M) which was mixed with diethylene glycol and triethylene in equal ratio. The components were kept under reflux for 4 hours at 180° C. Sodium acetate was then added and the system was refluxed for 2 additional hours at the same temperature. After cooling, the obtained zinc oxide nanoparticles were separated via centrifuge.

The synthesized zinc oxide nanoparticles were then dispersed in 0.1 liters of 0.4M NaOH under sonication for about 1 hour. Allyl chloride was then added in equal ratio to the present zinc oxide. The mixture was kept under reflux at 80° C. for 6 hours. After cooling, the product (allyl modified zinc oxide nanoparticles) was separated via centrifuge.

From the allyl modified zinc oxide nanoparticles, polymer modified zinc oxide nanoparticles were then prepared. To prepare the polymer modified (polymer grafted) zinc oxide nanoparticles, 5 g of the allyl modified zinc oxide nanoparticles was dispersed in dimethyl sulfoxide. Then, 10 g of acrylic acid was added under the flow of nitrogen. A polymerization reaction was then initiated by a potassium persulfate solution. The mixture was kept under reflux for 4 hours. Following reflux, the mixture was cooled and the polymer modified (polymer grafted) zinc oxide nanoparticles product was separated.

The polymer modified zinc oxide nanoparticles were then used to produce the final product, melamine polymer modified zinc oxide nanoparticles. Specifically, the previously produced polymer modified zinc oxide nanoparticles were first dispersed in dimethyl sulfoxide, and then 2.5 g of melamine was added to the dispersion, along with 0.2 mg of N,N′-Dicyclohexylcarbodiimide (DCC). The mixture was then stirred at 90° C. for 10 hours. The final product, melamine polymer modified zinc oxide nanoparticles, was then separated and dried.

### Example 2

In this example, corrosion resistance of exemplary melamine polymer modified zinc oxide nanoparticles of the present application was measured in a weight loss measurement experiment. The ASTM G1-03 standard methodology was used for the weight loss measurement. In this example, pre-weighed carbon steel specimens (blanks) were immersed entirely in duplicates in 100 ml of respective test solutions housed in 250 ml glass containers held at ambient temperature (25±1° C.) for 24 hours. The first test solution or acid system (control) was comprised of 5% HCl. The second test solution or acid system (experimental) was comprised of 5% HCl plus 300 ppm of melamine polymer modified zinc oxide nanoparticles. After the 24 hours, each specimen was removed from the respective test solutions, carefully cleansed and rinsed with distilled water and acetone, dried, and then weighed. The difference in weight before and after the specimens were immersed in test solution was utilized to calculate the weight loss and the average weight loss was used to compute the corrosion rate.

Table 1 (below) shows the weight loss results for modified melamine polymer modified zinc oxide nanoparticles inhibitor in the test solution. Equation (A) was used to calculate the % inhibition efficiency (% IE):

$$\% {IE}_{Wt Loss} = \frac{Weight after}{Weight before} \times 100 \qquad ( A )$$

As shown in the Table 1, the weight loss value for the specimen (blank) in the inhibited test solution was significantly lower than for the specimen in the control test solution (5% HCl) at 90° C. Accordingly, there was a significant inhibition efficiency of 98.38% for the melamine polymer modified zinc oxide nanoparticles in 5% HCl solution at 90° C.

TABLE 1
Weight loss measurement results for the blank in 5% HCl
test solution and the blank in a test solution of 300
ppm of melamine polymer modified zinc oxide nanoparticles
inhibitor and 5% HCl solutions, both at 90° C.

| | | Wt. Before | Wt. After | Weight | |
|---|---|---|---|---|---|
| Item | Acid System | (g) | (g) | Loss (g) | % IE |
| Blank | 5% HCl | 12.0376 | 10.189 | 1.8486 | — |
| Blank | 5% HCl (inhibited | 11.9732 | 11.779 | 0.1942 | 98.38% |
| | by 300 ppm | | | | |
| | melamine polymer | | | | |
| | modified zinc oxide | | | | |
| | nanoparticles) | | | | |

It is to be understood that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings according to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A method for synthesizing melamine polymer modified zinc oxide nanoparticles, comprising:
providing polymer grafted zinc oxide nanoparticles; and
grafting melamine onto the polymer grafted zinc oxide nanoparticles by adding melamine in the presence of a carboxy group activating reagent to the polymer grafted zinc oxide nanoparticles to form the melamine polymer modified zinc oxide nanoparticles.

2. The method of claim 1, wherein the carboxy group activating reagent comprises N,N′-Dicyclohexylcarbodiimide (DCC).

3. The method of claim 1, wherein the step of grafting melamine comprises dispersing the polymer grafted zinc oxide nanoparticles in a polar solvent.

4. The method of claim 3, wherein the polar solvent comprises dimethyl sulfoxide.

5. The method of claim 3, wherein the step of grafting melamine onto the polymer grafted zinc oxide nanoparticles further comprises stirring the polymer grafted zinc oxide nanoparticles, melamine, the polar solvent and the carboxy group activating reagent for about 2-8 hours at a temperature of about 60-100° C.

6. The method of claim 4, wherein the step of grafting melamine onto the polymer grafted zinc oxide nanoparticles further comprises stirring the polymer grafted zinc oxide nanoparticles, dimethyl sulfoxide, melamine, and N,N′-Dicyclohexylcarbodiimide as the carboxy group activating reagent for approximately 10 hours at approximately 90° C.

7. The method of claim 1, further comprising drying the melamine polymer modified zinc oxide nanoparticles.

8. The method of claim 1, wherein the polymer grafted zinc oxide nanoparticles are formed by:
mixing zinc acetate dihydrate with diethylene glycol and triethylene to form zinc oxide nanoparticles;
dispersing the zinc oxide nanoparticles in NaOH under sonication;
combining allyl chloride with the dispersed zinc oxide nanoparticles to form allyl modified zinc oxide nanoparticles, wherein the allyl chloride is added in an equal ratio to the zinc oxide;
dispersing the allyl modified zinc oxide nanoparticles in dimethyl sulfide;
adding acrylic acid to the dispersed allyl modified zinc oxide nanoparticles and initiating a polymerization reaction of the dispersed allyl modified zinc oxide nanoparticles with potassium persulfate solution to produce the polymer grafted zinc oxide nanoparticles.

9. The method of claim 8, wherein the diethylene glycol and triethylene are in equal ratio when mixed with zinc acetate dihydrate.

10. The method of claim 8, wherein the step of mixing zinc acetate dihydrate with diethylene glycol and triethylene includes refluxing the mixture of zinc acetate dihydrate, diethylene glycol, and triethylene.

11. The method of claim 10, wherein the step of mixing comprises:
refluxing the mixture of zinc acetate dihydrate, diethylene glycol, and triethylene for approximately 4 hours at 180° C.;
adding sodium acetate to the mixture;
further refluxing the mixture for approximately 2 hours at 180° C.; and
cooling the mixture.

12. The method of claim 8, wherein the acrylic acid is added to the dispersed allyl modified zinc oxide nanoparticles under the flow of nitrogen.

13. The method of claim 8, wherein the step of adding acrylic acid and initiating a polymerization reaction further comprises refluxing the mixture of acrylic acid, dispersed allyl modified zinc oxide nanoparticles and potassium persulfate solution for approximately 4 hours.

14. Zinc oxide nanoparticles comprising a melamine polymer of the following formula bonded to oxygen atoms:

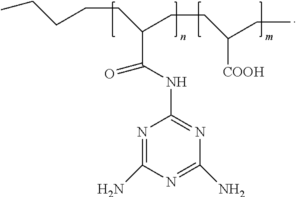

15. A method of corrosion inhibition in a wellbore, comprising:
applying a corrosion inhibitor composition comprising the melamine polymer modified zinc oxide nanoparticles of claim 14 to the wellbore.

16. The method of claim 15, wherein the wellbore comprises carbon steel.

17. The method of claim 15, wherein the corrosion inhibitor composition inhibits corrosion caused by one or more of hydrochloric acid, formic acid, acetic acid, hydrofluoric acid, nitric acid, sulfonic acid, and chloroacetic acid.
